(19) United States
(12) Patent Application Publication
(10) Pub. No.: US 2025/0323344 A1
(43) Pub. Date: Oct. 16, 2025

(54) SECONDARY BATTERY

(71) Applicant: Prime Planet Energy & Solutions, Inc., Tokyo (JP)

(72) Inventor: Daichi TAKEMOTO, Kobe-shi (JP)

(21) Appl. No.: 19/095,034

(22) Filed: Mar. 31, 2025

(30) Foreign Application Priority Data
Apr. 12, 2024 (JP) 2024-064790

(51) Int. Cl. H01M 10/653; H01M 10/0587; H01M 10/651; H01M 10/6555; H01M 50/103

(52) U.S. Cl. CPC H01M 10/653; H01M 10/0587; H01M 10/651; H01M 10/6555; H01M 50/103

(57) ABSTRACT

A secondary battery includes: an electrode assembly group including a first electrode assembly and a second electrode assembly; a first heat radiation plate disposed between the first electrode assembly and the second electrode assembly; a case that accommodates the electrode assembly group and the first heat radiation plate; and a second heat radiation plate accommodated in the case and disposed between an outer peripheral surface of the electrode assembly group and the case. Each of the first heat radiation plate and the second heat radiation plate has a thermal conductivity of 25 W/m·K or more and a volume resistivity of 1×10¹³ Ω·cm or more.

### CROSS REFERENCE TO RELATED APPLICATIONS

This nonprovisional application is based on Japanese Patent Application No. 2024-064790 filed on Apr. 12, 2024 with the Japan Patent Office, the entire contents of which are hereby incorporated by reference.

### BACKGROUND OF THE INVENTION

### Field of the Invention

The present invention relates to a secondary battery.

### Description of the Background Art

In order to attain a light weight of a secondary battery, it has been known to accommodate a plurality of electrode assemblies in a case (for example, Japanese Patent Laying-Open No. 2022-45560).

### SUMMARY OF THE INVENTION

A secondary battery may generate heat due to charging and discharging of an electrode assembly to increase its temperature, with the result that battery performance may be decreased. In a secondary battery in which a plurality of electrode assemblies are accommodated in a case, an amount of generated heat is likely to be large, and it is therefore required to suppress a temperature from being increased due to charging and discharging of the secondary battery.

An object of the present invention is to provide a secondary battery to attain a reduction of temperature increase due to generation of heat of an electrode assembly group even when the electrode assembly group, which includes a plurality of electrode assemblies, is accommodated in a case.

[1] A secondary battery comprising:
an electrode assembly group including a first electrode assembly and a second electrode assembly;
a first heat radiation plate disposed between the first electrode assembly and the second electrode assembly;
a case that accommodates the electrode assembly group and the first heat radiation plate; and
a second heat radiation plate accommodated in the case and disposed between an outer peripheral surface of the electrode assembly group and the case, wherein
each of the first heat radiation plate and the second heat radiation plate has a thermal conductivity of 25 W/m·K or more and has a volume resistivity of 1×10¹³ Ω·cm or more.

[2] The secondary battery according to [1], wherein the first heat radiation plate and the second heat radiation plate are formed to conduct heat between the first heat radiation plate and the second heat radiation plate.

[3] The secondary battery according to [1] or [2], wherein each of the first heat radiation plate and the second heat radiation plate has a thermal conductivity of 130 W/m·K or more.

[4] The secondary battery according to any one of [1] to [3], wherein each of the first heat radiation plate and the second heat radiation plate includes aluminum nitride.

[5] The secondary battery according to any one of [1] to [4], wherein the second heat radiation plate is an electrode assembly holder that accommodates the electrode assembly group in an inner space of the electrode assembly holder.

[6] The secondary battery according to any one of [1] to [5], wherein
each of the first electrode assembly and the second electrode assembly has a structure in which a negative electrode, a positive electrode, and a separator interposed between the negative electrode and the positive electrode are stacked,
the first electrode assembly and the second electrode assembly in the electrode assembly group are arranged such that a stacking direction of the negative electrode, the positive electrode, and the separator in the first electrode assembly and a stacking direction of the negative electrode, the positive electrode, and the separator in the second electrode assembly are the same direction,
the electrode assembly group has a first electrode tab group disposed at a first end portion of the electrode assembly group, and a second electrode tab group disposed at a second end portion of the electrode assembly group opposite to the first end portion,
the outer peripheral surface of the electrode assembly group has a first end surface provided with the first electrode tab group and a second end surface provided with the second electrode tab group, and
a length of the electrode assembly group in a first direction in which the first end surface and the second end surface are arranged is larger than a length of the electrode assembly group in the stacking direction and is larger than a length of the electrode assembly group in a second direction orthogonal to the first direction and the stacking direction.

[7] The secondary battery according to [6], wherein the second heat radiation plate is disposed between the case and each of all surfaces of the outer peripheral surface of the electrode assembly group except for the first end surface and the second end surface.

[8] The secondary battery according to [6] or [7], wherein a relation of the following formula (I) is satisfied:

0.97≤Lhx/Lsx<1 (I), where
Lhx represents a length of the first heat radiation plate in the first direction and Lsx represents a length of the separator in the first electrode assembly or the second electrode assembly in the first direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a configuration of a secondary battery according to an embodiment.

FIG. 2 is a front view showing the configuration of the secondary battery shown in FIG. 1.

FIG. 3 is a front cross sectional view of the secondary battery shown in FIG. 2.

FIG. 4 is a perspective view showing a state in which a second heat radiation plate is attached to an electrode assembly group.

FIG. 5 is a cross sectional view of the secondary battery shown in FIG. 1 along V-V.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

In the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

In the present specification, the terms “comprise”, “include”, and “have” are open-end terms. That is, when a certain configuration is included, a configuration other than the foregoing configuration may or may not be included.

In the present specification, when geometric terms and terms representing positional/directional relations are used, for example, when terms such as “parallel”, “orthogonal”, “along”, and the like are used, these terms permit manufacturing errors or slight fluctuations. In the present specification, when terms representing relative positional relations such as “upper surface”, “bottom surface”, and “side surface” are used, each of these terms is used to indicate a relative positional relation in one state, and the relative positional relation may be reversed or turned at any angle in accordance with an installation direction of each mechanism (for example, the entire mechanism is reversed upside down).

In the present specification, a numerical range such as “m to n” includes the lower and upper limit values unless otherwise stated particularly. That is, “m to n” indicates a numeric value range of “m or more and n or less”. A numerical value freely selected from the numerical range may be employed as a new lower or upper limit value. For example, a new numerical range may be set by freely combining a numerical value described in the numerical range with a numerical value described in another portion of the present specification.

In the present specification, the term “secondary battery” is not limited to a lithium ion battery, and may include other secondary batteries such as a nickel-metal hydride battery and a sodium-ion battery.

In the figures, when an electrode assembly included in the secondary battery is a stacked type electrode assembly, an X direction (first direction) is defined as a long-side direction of a stacked surface, whereas when the electrode assembly is a wound type electrode assembly, the X direction (first direction) is defined as a direction along a winding axis thereof. Further, a Y direction (stacking direction) is defined as a short-side direction of the electrode assembly when viewed in the X direction, and a Z direction (second direction) is defined as a direction orthogonal to the X direction and the Y direction, i.e., as a direction orthogonal to the X direction and corresponding to the long-side direction of the electrode assembly when viewed in the X direction. In order to facilitate understanding of the invention, the size of each configuration in the figures may be illustrated to be changed from its actual size.

In the specification of the present application, the “X direction”, the “Z direction”, and the “Y direction” in the explanations for the secondary battery, the electrode assembly, the electrode assembly group, the case main body, and the like may be referred to as a “width direction”, a “height direction”, and a “thickness direction”, respectively.

### (Overall Configuration of Secondary Battery)

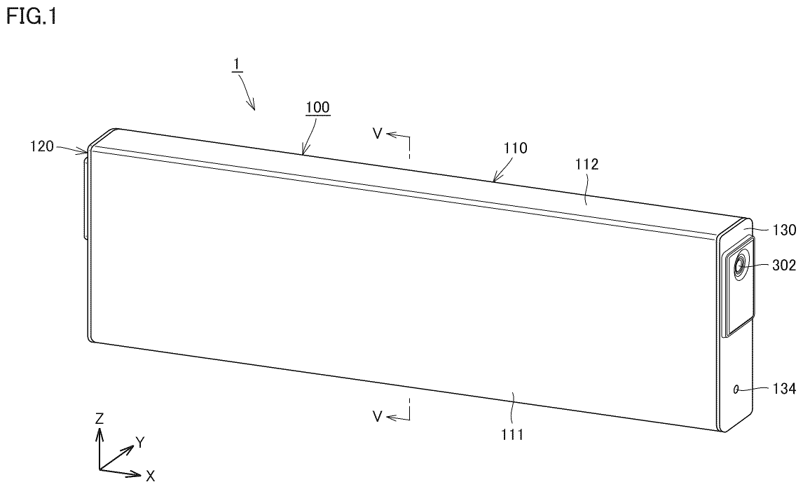

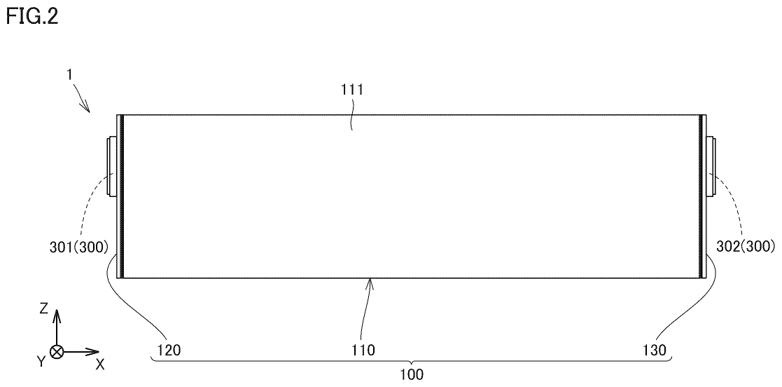

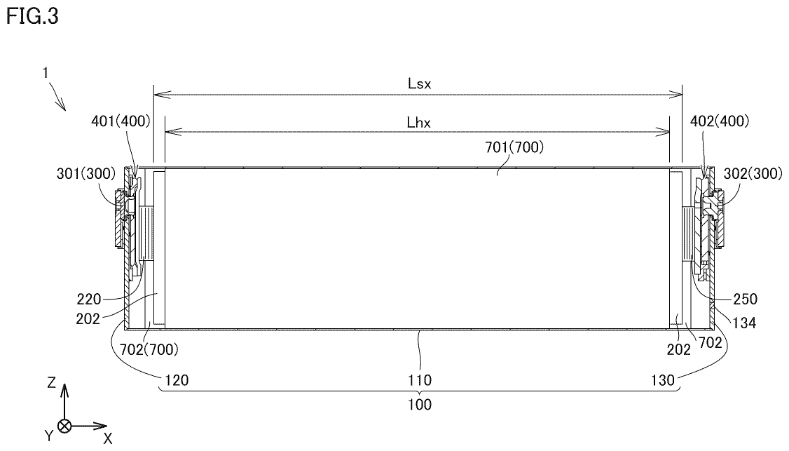

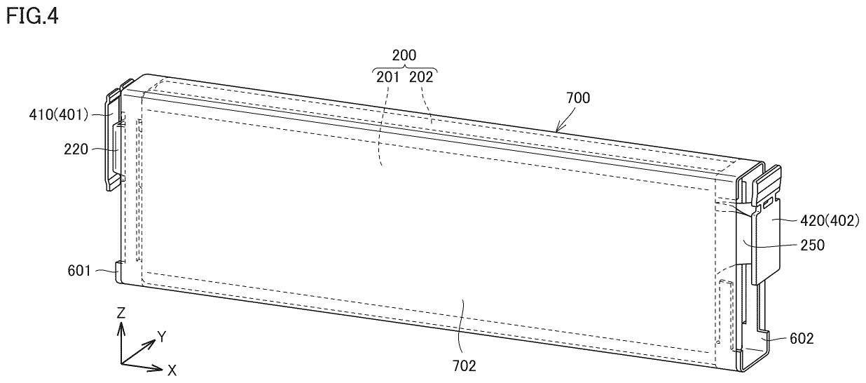

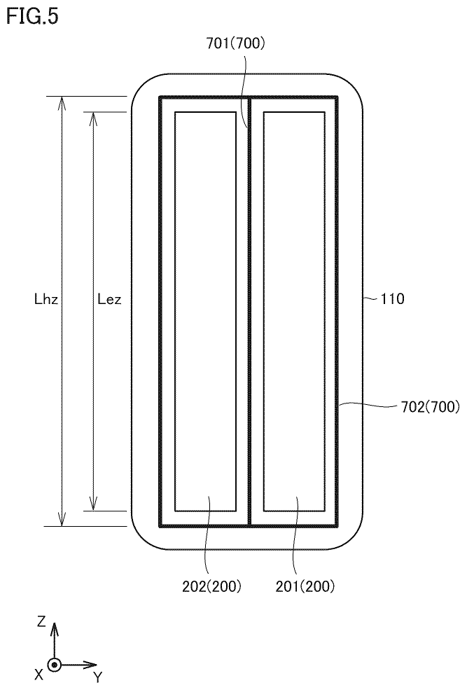

FIG. 1 is a perspective view showing a configuration of a secondary battery according to an embodiment. FIG. 2 is a front view showing the configuration of the secondary battery shown in FIG. 1. FIG. 3 is a front cross sectional view of the secondary battery shown in FIG. 2. FIG. 4 is a perspective view showing a state in which a second heat radiation plate is attached to an electrode assembly group. FIG. 5 is a cross sectional view of the secondary battery shown in FIG. 1 along V-V.

As shown in FIGS. 1 to 5, a secondary battery 1 includes a case 100, an electrode assembly group 200, an electrode terminal 300, a current collector 400, and a heat radiation plate 700.

Case 100 accommodates electrode assembly group 200 and heat radiation plate 700. As shown in FIGS. 4 and 5, heat radiation plate 700 includes a below-described first heat radiation plate 701 and a below-described second heat radiation plate 702. First heat radiation plate 701 and second heat radiation plate 702 are accommodated in case 100 together with electrode assembly group 200. Electrode assembly group 200 is accommodated in case 100 together with an electrolyte solution with electrode assembly group 200 being disposed in an inner space formed by second heat radiation plate 702 (FIG. 4). The electrolyte solution is such that an electrolyte is contained in a nonaqueous solvent such as an organic solvent. Second heat radiation plate 702 may be an electrode assembly holder that is disposed between electrode assembly group 200 and case 100 and that accommodates electrode assembly group 200 in the inner space.

Case 100 can include a case main body 110, a first sealing plate 120, and a second sealing plate 130. Case main body 110 has a tubular shape, preferably a prismatic tubular shape. A corner portion of the prismatic tubular shape may have a shape with a curvature. Each of case main body 110, first sealing plate 120, and second sealing plate 130 is composed of a metal, such as aluminum, an aluminum alloy, iron, or an iron alloy, for example.

In the present embodiment, the length of case main body 110 in the width direction (X direction) of secondary battery 1 is larger than the length thereof in each of the thickness direction (Y direction) and the height direction (Z direction) of secondary battery 1. The size (width) of case main body 110 in the X direction is preferably 30 cm or more. In this way, secondary battery 1 can be formed to have a relatively large size (high capacity). The size (height) of case main body 110 in the Z direction is preferably 20 cm or less, more preferably 15 cm or less, and further preferably 10 cm or less. Thus, (low-height) secondary battery 1 having a relatively low height can be formed, thus resulting in improved ease of mounting on a vehicle, for example.

Case main body 110 includes a pair of first side surface portions 111 and a pair of second side surface portions 112. The pair of first side surface portions 111 constitute parts of the side surfaces of case 100. The pair of second side surface portions 112 constitute the bottom surface portion and upper surface portion of case 100. The pair of first side surface portions 111 and the pair of second side surface portions 112 are provided to intersect each other. The pair of first side surface portions 111 and the pair of second side surface portions 112 are connected at their respective end portions. Each of the pair of first side surface portions 111 preferably has an area larger than that of each of the pair of second side surface portions 112.

A first opening is provided at an end portion of case main body 110 on a first side in the X direction. As shown in FIGS. 1 to 3, the first opening is sealed by first sealing plate 120, and case main body 110 and first sealing plate 120 are joined by a joining portion. Each of the first opening and first sealing plate 120 has a substantially rectangular shape in which the Y direction corresponds to its short-side direction and the Z direction corresponds to its long-side direction. The substantially rectangular shape includes a rectangular shape or a generally rectangular shape such as a rectangular shape having corners each with a curvature.

A negative electrode terminal 301 (electrode terminal 300) is provided on first sealing plate 120. The position of negative electrode terminal 301 can be appropriately changed. Negative electrode terminal 301 is electrically connected to a negative electrode of electrode assembly group 200. Negative electrode terminal 301 is attached to first sealing plate 120, i.e., case 100. Negative electrode terminal 301 can be composed of a conductive material, and can be composed of a metal such as copper or a copper alloy, for example.

A second opening is provided at an end portion of case main body 110 on a second side opposite to the end portion on the first side in the X direction. The second opening is located at an end portion opposite to the first opening, and the first opening and the second opening face each other. As shown in FIGS. 1 to 3, the second opening is sealed by second sealing plate 130, and case main body 110 and second sealing plate 130 are joined by a joining portion. Each of the second opening and second sealing plate 130 has a substantially rectangular shape in which the Y direction corresponds to its short-side direction and the Z direction corresponds to its long-side direction.

Second sealing plate 130 is provided with a positive electrode terminal 302 (electrode terminal 300) and an injection hole 134. The positions of positive electrode terminal 302 and injection hole 134 can be appropriately changed. Positive electrode terminal 302 is electrically connected to a positive electrode of electrode assembly group 200. Positive electrode terminal 302 is attached to second sealing plate 130, i.e., case 100. Positive electrode terminal 302 can be composed of a conductive material, and can be composed of a metal such as aluminum or an aluminum alloy, for example. Injection hole 134 is sealed by a sealing member (not shown). As the sealing member, for example, a blind rivet or another metal member can be used.

Electrode assembly group 200 includes a first electrode assembly 201 and a second electrode assembly 202 (hereinafter, also simply referred to as “electrode assemblies 201, 202”). Electrode assembly group 200 should at least include electrode assemblies 201, 202, and may include an electrode assembly other than electrode assemblies 201, 202. The number of the electrode assemblies included in electrode assembly group 200 is not particularly limited, but is preferably 2 to 4, more preferably 2 or 4, and further preferably 2.

Each of electrode assemblies 201, 202 has a structure in which a negative electrode, a positive electrode, and a separator interposed between the negative electrode and the positive electrode are stacked. Each of electrode assemblies 201, 202 may be a stacked type electrode assembly in which a plurality of negative electrodes and a plurality of positive electrodes are alternately stacked with separators being interposed therebetween, or may be a wound type electrode assembly obtained by winding a strip-shaped stack in which a strip-shaped negative electrode and a strip-shaped positive electrode are stacked with a strip-shaped separator being interposed therebetween. When each of electrode assemblies 201, 202 is the wound type electrode assembly, each of electrode assemblies 201, 202 preferably has a flat shape by pressing the stack after the stack is wound.

Electrode assemblies 201, 202 in electrode assembly group 200 are arranged such that a stacking direction of the negative electrode, the positive electrode, and the separator in electrode assembly 201 and a stacking direction of the negative electrode, the positive electrode, and the separator in electrode assembly 202 are the same direction. For example, in secondary battery 1 shown in FIGS. 1 to 5, the stacking direction of the negative electrode, the positive electrode, and the separator is the Y direction, and first electrode assembly 201 and second electrode assembly 202 are arranged in the Y direction. When each of electrode assemblies 201, 202 is the stacked type electrode assembly, electrode assembly group 200 is formed in which electrode assemblies 201, 202 are arranged such that the negative electrode, the positive electrode, and the separator in each of electrode assemblies 201, 202 are stacked in the Y direction. When each of electrode assemblies 201, 202 is the wound type electrode assembly, electrode assembly group 200 is formed in which electrode assemblies 201, 202 are arranged in the Y direction such that the winding axes thereof are parallel to each other. Thus, electrode assemblies 201, 202 that are each the wound type electrode assembly are also arranged such that the stacking direction of the negative electrode, the positive electrode, and the separator in electrode assembly 201 and the stacking direction of the negative electrode, the positive electrode, and the separator in electrode assembly 202 are the same direction. First electrode assembly 201 and second electrode assembly 202 in electrode assembly group 200 are preferably arranged such that the surfaces (surfaces of electrode assemblies 201, 202 facing the pair of first side surface portions 111 of case main body 110 in the present embodiment) thereof each having the largest area among the surfaces included in the outer surface face each other (FIG. 4).

As shown in FIGS. 3 and 4, electrode assembly group 200 includes a main body portion, a negative electrode tab group 220 (first electrode tab group), and a positive electrode tab group 250 (second electrode tab group). The main body portion is a portion in which the negative electrodes, the positive electrodes, and the separators included in electrode assemblies 201, 202 are stacked, and corresponds to a rectangular portion other than negative electrode tab group 220 and positive electrode tab group 250. Negative electrode tab group 220 is a portion in which negative electrode tabs included in electrode assemblies 201, 202 are stacked. Positive electrode tab group 250 is a portion in which positive electrode tabs included in electrode assemblies 201, 202 are stacked. Negative electrode tab group 220 and positive electrode tab group 250 are formed to protrude from the main body portion toward first sealing plate 120 and second sealing plate 130, respectively. Negative electrode tab group 220 is disposed at a first end portion of electrode assembly group 200, i.e., one end portion of electrode assembly group 200 in the X direction with respect to the main body portion in the present embodiment. The first end portion side in the present embodiment is the first sealing plate 120 side. Positive electrode tab group 250 is disposed at a second end portion of electrode assembly group 200 opposite to the first end portion, i.e., an end portion of electrode assembly group 200 opposite to the first end portion side in the X direction with respect to the main body portion. The second end portion side in the present embodiment is the second sealing plate 130 side.

The outer peripheral surface of electrode assembly group 200 has a first end surface provided with negative electrode tab group 220 located at the first end portion, and a second end surface provided with positive electrode tab group 250 located at the second end portion opposite to the first end portion. In the present embodiment, the second end surface is located opposite to the first end surface in the X direction, and the X direction is the first direction in which the first end surface and the second end surface are arranged. The length of electrode assembly group 200 in the X direction (first direction) is larger than the length of electrode assembly group 200 in the stacking direction (Y direction) of the negative electrode, the positive electrode, and the separator, and is larger than the length of electrode assembly group 200 in the Z direction (second direction) orthogonal to the X direction and the stacking direction. Similarly, the length of each of electrode assemblies 201, 202 in the X direction (width direction; first direction) is larger than the length of each of electrode assemblies 201, 202 in each of the Y direction (thickness direction; stacking direction) and the Z direction (height direction; second direction). Electrode assembly group 200 is accommodated in case 100 such that the long-side direction thereof is parallel to the X direction.

The negative electrode includes a negative electrode current collector foil and a negative electrode active material layer formed on the negative electrode current collector foil. The negative electrode current collector foil is a copper foil or a copper alloy foil. The negative electrode active material layer can be formed on one surface or each of both surfaces of the negative electrode current collector foil. The negative electrode active material layer includes a negative electrode active material such as graphite, and can further include a binder such as carboxymethyl cellulose and styrene-butadiene rubber, a conductive auxiliary agent such as carbon black and fibrous carbon, and the like. One end portion of the negative electrode is provided with a negative electrode tab constituted of the negative electrode current collector foil on which no negative electrode active material layer is formed. When each of electrode assemblies 201, 202 is the stacked type electrode assembly, negative electrode tabs provided in the respective negative electrodes are stacked to form negative electrode tab group 220. When each of electrode assemblies 201, 202 is the wound type electrode assembly, a plurality of negative electrode tabs formed in the strip-shaped negative electrode are stacked to form negative electrode tab group 220. The length and shape of each of the plurality of negative electrode tabs in the protruding direction thereof are appropriately adjusted in consideration of a state in which negative electrode tab group 220 is connected to a negative electrode current collector 401.

The positive electrode includes a positive electrode current collector foil and a positive electrode active material layer formed on the positive electrode current collector foil. The positive electrode current collector foil is an aluminum foil or an aluminum alloy foil. The positive electrode active material layer can be formed on one surface or each of both surfaces of the positive electrode current collector foil. The positive electrode active material layer includes a positive electrode active material such as a lithium transition metal composite oxide, and can further include a binder such as polyvinylidene difluoride, a conductive auxiliary agent such as carbon black and fibrous carbon, and the like. One end portion of the positive electrode is provided with a positive electrode tab constituted of the positive electrode current collector foil on which no positive electrode active material layer is formed. When each of electrode assemblies 201, 202 is the stacked type electrode assembly, positive electrode tabs provided in the respective positive electrodes are stacked to form positive electrode tab group 250. When each of electrode assemblies 201, 202 is the wound type electrode assembly, a plurality of positive electrode tabs formed in the strip-shaped positive electrode are stacked to form positive electrode tab group 250. The length and shape of each of the plurality of positive electrode tabs in the protruding direction thereof are appropriately adjusted in consideration of a state in which positive electrode tab group 250 is connected to a positive electrode current collector 402.

As shown in FIG. 3, current collector 400 includes negative electrode current collector 401 and positive electrode current collector 402. Each of negative electrode current collector 401 and positive electrode current collector 402 is formed from a plate-shaped member. Electrode assembly group 200 is electrically connected to negative electrode terminal 301 via negative electrode tab group 220 and negative electrode current collector 401, and is electrically connected to positive electrode terminal 302 via positive electrode tab group 250 and positive electrode current collector 402.

Negative electrode current collector 401 is disposed on first sealing plate 120 with an insulating member composed of resin being interposed therebetween. Negative electrode current collector 401 is electrically connected to negative electrode tab group 220 and negative electrode terminal 301. Negative electrode current collector 401 can be composed of a conductive material, for example, a metal such as aluminum or an aluminum alloy. Negative electrode current collector 401 has a first conductive member 410 (FIG. 4) joined to negative electrode tab group 220 and a second conductive member joined to negative electrode terminal 301. First conductive member 410 and the second conductive member are electrically connected to each other to form negative electrode current collector 401 (FIG. 3).

Positive electrode current collector 402 is disposed on second sealing plate 130 with an insulating member composed of resin being interposed therebetween. Positive electrode current collector 402 is electrically connected to positive electrode tab group 250 and positive electrode terminal 302. Positive electrode current collector 402 can be composed of a conductive material, for example, a metal such as aluminum or an aluminum alloy. Positive electrode current collector 402 has a third conductive member 420 (FIG. 4) joined to positive electrode tab group 250 and a fourth conductive member joined to positive electrode terminal 302. Third conductive member 420 and the fourth conductive member are electrically connected to each other to form positive electrode current collector 402 (FIG. 3).

A first spacer 601 is disposed between first sealing plate 120 and the main body portion of electrode assembly group 200 (FIG. 4). A second spacer 602 is disposed between second sealing plate 130 and the main body portion of electrode assembly group 200 (FIG. 4). Each of first spacer 601 and second spacer 602 (hereinafter, also referred to as “spacers 601, 602”) is composed of a material having an insulating property. Negative electrode tab group 220 passes through inside of first spacer 601 and is accordingly protected by first spacer 601. Positive electrode tab group 250 passes through inside of second spacer 602 and is accordingly protected by second spacer 602. Thus, electrical contact can be suppressed between negative electrode tab group 220 and first sealing plate 120 and between positive electrode tab group 250 and second sealing plate 130. Moreover, electrical contact can also be suppressed between each of negative electrode tab group 220 and positive electrode tab group 250 and each of first side surface portion 111 and second side surface portion 112 of case main body 110. Secondary battery 1 may have a configuration in which spacers 601, 602 are not provided.

Portions of spacers 601, 602 may respectively have plate portions facing a portion of the first end surface (described above) and a portion of the second end surface (described above) of electrode assembly group 200. Each of the plate portions may be in abutment with the main body portion of electrode assembly group 200, or even when each of the plate portions is not in abutment with the main body portion, the shortest distance to electrode assembly group 200 therefrom is preferably 2 mm or less, and more preferably 1 mm or less.

Examples of the material which has an insulating property and of which each of spacers 601, 602 is composed include: a resin material such as polypropylene (PP), polyethylene terephthalate (PET), polyphenylene sulfide (PPS), polyimide (PI), or polyolefin (PO); a material of which heat radiation plate 700 described below is composed; and the like. When each of spacers 601, 602 is composed of the material of which heat radiation plate 700 is composed, each of spacers 601, 602 can also function as heat radiation plate 700 described below.

### (Structure and Property of Heat Radiation Plate)

As shown in FIGS. 4 and 5, heat radiation plate 700 includes a below-described first heat radiation plate 701 and a below-described second heat radiation plate 702. First heat radiation plate 701 and second heat radiation plate 702 may be separate members or may be formed in one piece.

As shown in FIG. 5, first heat radiation plate 701 is accommodated in case 100 together with electrode assembly group 200. First heat radiation plate 701 is disposed between first electrode assembly 201 and second electrode assembly 202 accommodated in case 100. A clearance may be present between first electrode assembly 201 and first heat radiation plate 701 and first electrode assembly 201 and first heat radiation plate 701 may not be in contact with each other. From the viewpoint of improving heat radiation efficiency of first heat radiation plate 701, first electrode assembly 201 and first heat radiation plate 701 may be in contact with each other. A clearance may be present between second electrode assembly 202 and first heat radiation plate 701 and second electrode assembly 202 and first heat radiation plate 701 may not be in contact with each other. From the viewpoint of improving the heat radiation efficiency of first heat radiation plate 701, first heat radiation plate 701 and second electrode assembly 202 may be in contact with each other.

First heat radiation plate 701 is preferably disposed in a range facing the main body portion (portion in which the negative electrode and the positive electrode are stacked with the separator being interposed therebetween) of electrode assembly group 200. First heat radiation plate 701 is preferably not disposed at a position facing each of negative electrode tab group 220 and positive electrode tab group 250.

As shown in FIG. 3, secondary battery 1 preferably satisfies a relation of the following formula (I):

0.97≤Lhx/Lsx<1 (I), where

Lhx represents the length of first heat radiation plate 701 in the X direction (first direction) and Lsx represents the length of the separator in first electrode assembly 201 or second electrode assembly 202 in the X direction (first direction).

Lsx represents the length of the separator in the X direction at the surface of each of electrode assemblies 201, 202 facing first heat radiation plate 701. Lsx may represent the length of the separator of first electrode assembly 201 or the length of the separator of second electrode assembly 202. Lhx/Lsx may be 0.98 to 0.99. When Lhx/Lsx falls within the above range, contact between first heat radiation plate 701 and each of negative electrode tab group 220 and positive electrode tab group 250 can be reduced in secondary battery 1 while attaining a large heat radiation area of first heat radiation plate 701.

As shown in FIG. 5, secondary battery 1 preferably satisfies a relation of the following formula (II):

Lhz/Lez≥1 (II), where

Lhz represents the length of first heat radiation plate 701 in the Z direction (height direction) and Lez represents the length of electrode assembly group 200 in the Z direction.

Lez represents the length thereof in the Z direction at the surface of each of electrode assemblies 201, 202 facing first heat radiation plate 701. In the present embodiment, the Z direction is a direction orthogonal to the X direction at the surface of each of electrode assemblies 201, 202 facing first heat radiation plate 701. Lhz/Lez may be more than 1, may be 1 to 1.2, may be more than 1 and 1.1 or less, or may be 1.01 to 1.07. When Lhz/Lez falls within the above range, the heat radiation area of heat radiation plate 702 can be large. When secondary battery 1 satisfies the relations of the formulas (I) and (II), the heat radiation area of second heat radiation plate 702 can be large, thus resulting in improved heat radiation efficiency.

Second heat radiation plate 702 is accommodated in case 100, and is disposed between the outer peripheral surface of electrode assembly group 200 and case 100. As shown in FIGS. 4 and 5, second heat radiation plate 702 is disposed to face at least a portion of the outer peripheral surface of electrode assembly group 200. Second heat radiation plate 702 faces 50% or more, more preferably 70% or more of the area of the outer peripheral surface of electrode assembly group 200. A clearance is present between second heat radiation plate 702 and electrode assembly group 200, and second heat radiation plate 702 and electrode assembly group 200 may not be in contact with each other. From the viewpoint of improving heat radiation efficiency by second heat radiation plate 702, second heat radiation plate 702 and electrode assembly group 200 are preferably in contact with each other.

When secondary battery 1 has spacers 601, 602 between first sealing plate 120 and the main body portion of electrode assembly group 200 and between second sealing plate 130 and the main body portion of electrode assembly group 200 (FIG. 4), second heat radiation plate 702 may also be disposed between case 100 and the outer peripheral surface of each of spacers 601, 602. In this case, second heat radiation plate 702 may be fixed to the outer peripheral surface of each of spacers 601, 602. Examples of a method for fixing second heat radiation plate 702 to each of spacers 601, 602 include thermal welding, adhesion with a tape, adhesion with an adhesive agent, fitting, hooking, and the like.

When secondary battery 1 has spacers 601, 602, second heat radiation plate 702 may include spacers 601, 602, i.e., a portion of second heat radiation plate 702 may function as a whole of each of spacers 601, 602 or a part of each of spacers 601, 602. For example, second heat radiation plate 702 may constitute the plate portions (described above) of spacers 601, 602 facing the first end surface and the second end surface of electrode assembly group 200, i.e., the plate portions may be included in second heat radiation plate 702. Alternatively, second heat radiation plate 702 may constitute spacers 601, 602. Second heat radiation plate 702 may include only one of spacers 601, 602, or may include only one of the plate portion of first spacer 601 and the plate portion of second spacer 602.

Second heat radiation plate 702 is preferably not disposed between the first end surface (surface provided with negative electrode tab group 220) of electrode assembly group 200 and case 100, and between the second end surface (surface provided with positive electrode tab group 250) and case 100. Preferably, second heat radiation plate 702 is disposed between case 100 and each of all the surfaces (hereinafter, also referred to as “remaining surfaces”) of the outer peripheral surface of electrode assembly group 200 except for the first end surface and the second end surface. Second heat radiation plate 702 facing all the remaining surfaces may face a portion of each of the remaining surfaces, may face a whole of each of the remaining surfaces, or may face portions of parts of the remaining surfaces and whole of parts of the remaining surfaces.

Second heat radiation plate 702 is preferably disposed to face the whole of the outer peripheral surface of the main body portion of electrode assembly group 200, and is more preferably disposed also to face at least the root side (portion on the main body portion side) of each of negative electrode tab group 220 and positive electrode tab group 250. Second heat radiation plate 702 may be disposed to face the main body portion, the whole of negative electrode tab group 220, and the whole of positive electrode tab group 250. By disposing second heat radiation plate 702 to face negative electrode tab group 220 and positive electrode tab group 250, electrical contact of each of negative electrode tab group 220 and positive electrode tab group 250 with case 100 can be reduced, with the result that insulation between electrode assembly group 200 and case 100 can be maintained. As described above, second heat radiation plate 702 disposed between case 100 and each of negative electrode tab group 220 and positive electrode tab group 250 may be spacers 601, 602.

As shown in FIGS. 4 and 5, second heat radiation plate 702 is preferably formed to have a tubular shape, and is formed to have a tubular shape so as to face all the remaining surfaces of electrode assembly group 200. Thus, the heat radiation area of second heat radiation plate 702 can be large to improve the heat radiation efficiency, with the result that the insulation between electrode assembly group 200 and case 100 can be facilitated to be maintained. Second heat radiation plate 702 having such a tubular shape may be formed by bending a plate-shaped member or a sheet-shaped member. The plate-shaped member or sheet-shaped member may be bent into the tubular shape by bringing end sides thereof into abutment with each other, or may be bent into the tubular shape by overlapping the end sides with each other.

First heat radiation plate 701 and second heat radiation plate 702 are preferably formed to conduct heat between first heat radiation plate 701 and second heat radiation plate 702. Examples of a method of forming them to conduct heat therebetween include: a method of connecting first heat radiation plate 701 and second heat radiation plate 702 by bringing them into contact with each other or the like; a method of forming first heat radiation plate 701 and second heat radiation plate 702 in one piece by bending one plate-shaped member or one sheet-shaped member so as to form first heat radiation plate 701 and second heat radiation plate 702; a combination thereof; and the like. Thus, since the heat of first heat radiation plate 701 can be conducted to second heat radiation plate 702, the heat of first heat radiation plate 701 can be efficiently radiated from second heat radiation plate 702.

Each of first heat radiation plate 701 and second heat radiation plate 702 (hereinafter, also simply referred to as “heat radiation plates 701, 702”) has a thermal conductivity of 25 W/m·K or more and a volume resistivity of 1×10¹³ Ω·cm or more. In the present specification, each of the thermal conductivity and the volume resistivity indicates a value at a temperature of 25° C.

The thermal conductivity of each of heat radiation plates 701, 702 may be 100 W/m·K or more, is preferably 130 W/m·K or more, may be 150 W/m·K or more, or may be 200 W/m·K or more. Generally, the thermal conductivity of each of heat radiation plates 701, 702 is 250 W/m·K or less. Heat radiation plates 701, 702 may have the same thermal conductivity or different thermal conductivities. When second heat radiation plate 702 includes spacers 601, 602, the portions of second heat radiation plate 702 corresponding to spacers 601, 602 and the portions of second heat radiation plate 702 other than spacers 601, 602 may have the same thermal conductivity or different thermal conductivities. The thermal conductivity of each of heat radiation plates 701, 702 is found by a method compliant with ASTM D5470.

The volume resistivity of each of heat radiation plates 701, 702 may be 5×10¹³ Ω·cm or more, 1×10¹⁴ Ω·cm or more, or 5×10¹⁴ Ω·cm or more. Generally, the volume resistivity of each of heat radiation plates 701, 702 is 1×10¹⁶ Ω·cm or less. Heat radiation plates 701, 702 may have the same volume resistivity or different volume resistivities. When second heat radiation plate 702 includes spacers 601, 602, the portions of second heat radiation plate 702 corresponding to spacers 601, 602 and the portions of second heat radiation plate 702 other than spacers 601, 602 may have the same volume resistivity or different volume resistivities. The volume resistivity of each of heat radiation plates 701, 702 is found by a method compliant with JIS C2141.

The thermal conductivities and volume resistivities of heat radiation plates 701, 702 can be freely combined within the above-described ranges. The thermal conductivities and volume resistivities of heat radiation plates 701, 702 may be the same or different, the thermal conductivities of heat radiation plates 701, 702 may be the same and the volume resistivities of heat radiation plates 701, 702 may be different, or the volume resistivities of heat radiation plates 701, 702 may be the same and the thermal conductivities of heat radiation plates 701, 702 may be different.

Each of heat radiation plates 701, 702 can be formed using a material having the above-described thermal conductivity and volume resistivity. Examples of such a material include one or more materials selected from a group consisting of aluminum nitride, silicon nitride, aluminum oxide, and diamond-like carbon. The materials of heat radiation plates 701, 702 may be the same or different. From the viewpoint of achieving excellent thermal conductivity and volume resistivity, each of heat radiation plates 701, 702 preferably includes aluminum nitride.

In secondary battery 1, heat is generated due to charging and discharging of electrode assembly group 200 accommodated in case 100. When secondary battery 1 is rapidly charged, an amount of generated heat also becomes large. Secondary battery 1 includes first heat radiation plate 701 disposed between two electrode assemblies 201, 202 included in electrode assembly group 200, and further includes second heat radiation plate 702 disposed between the outer peripheral surface of electrode assembly group 200 and case 100. Therefore, the heat generated in electrode assembly group 200 can be radiated from heat radiation plates 701, 702. Since secondary battery 1 has first heat radiation plate 701, the heat radiation area can be increased as compared with a case where secondary battery 1 has only second heat radiation plate 702, thus resulting in improved heat radiation efficiency. Moreover, even when secondary battery 1 is rapidly charged, the heat generated by electrode assembly group 200 can be efficiently radiated. Thus, a time of charging of secondary battery 1 can be shortened and the number of times of performing charging per day can be increased, with the result that secondary battery 1 excellent in rapid charging performance can be provided.

Since each of heat radiation plates 701, 702 has the above-described volume resistivity, insulation between first electrode assembly 201 and second electrode assembly 202 and insulation between electrode assembly group 200 and case 100 can be maintained. Therefore, second heat radiation plate 702 can be used not only as a heat radiation member but also as an electrode assembly holder disposed between electrode assembly group 200 and case 100 to insulate electrode assembly group 200 and case 100 from each other. When second heat radiation plate 702 is such an electrode assembly holder, first heat radiation plate 701 can be used as a partition wall for partitioning the inside of the electrode assembly holder so as to form inner spaces in which first electrode assembly 201 and second electrode assembly 202 are respectively accommodated.

In the present embodiment, it has been described that electrode assembly group 200 has electrode assemblies 201, 202; however, electrode assembly group 200 may include three or more electrode assemblies. When electrode assembly group 200 includes three or more electrode assemblies, first heat radiation plate 701 may be disposed between any adjacent electrode assemblies, but first heat radiation plates 701 are preferably between all the adjacent electrode assemblies.

In the present embodiment, it has been described that negative electrode tab group 220 and positive electrode tab group 250 are disposed respectively at the end portions of electrode assembly group 200 in the X direction (first direction), but it is not limited thereto. For example, negative electrode tab group 220 and positive electrode tab group 250 may be disposed at the same end portion of electrode assembly group 200.

In the present embodiment, it has been described that the length of electrode assembly group 200 in the X direction (first direction) is larger than each of the lengths thereof in the Y direction (stacking direction) and the Z direction (second direction), but it is not limited thereto, and the length thereof in each direction can be set as appropriate.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A secondary battery comprising:
an electrode assembly group including a first electrode assembly and a second electrode assembly;
a first heat radiation plate disposed between the first electrode assembly and the second electrode assembly;
a case that accommodates the electrode assembly group and the first heat radiation plate; and
a second heat radiation plate accommodated in the case and disposed between an outer peripheral surface of the electrode assembly group and the case, wherein
each of the first heat radiation plate and the second heat radiation plate has a thermal conductivity of 25 W/m·K or more and has a volume resistivity of 1×10¹³ Ω·cm or more.

2. The secondary battery according to claim 1, wherein the first heat radiation plate and the second heat radiation plate are formed to conduct heat between the first heat radiation plate and the second heat radiation plate.

3. The secondary battery according to claim 1, wherein each of the first heat radiation plate and the second heat radiation plate has a thermal conductivity of 130 W/m·K or more.

4. The secondary battery according to claim 1, wherein each of the first heat radiation plate and the second heat radiation plate includes aluminum nitride.

5. The secondary battery according to claim 1, wherein the second heat radiation plate is an electrode assembly holder that accommodates the electrode assembly group in an inner space of the electrode assembly holder.

6. The secondary battery according to claim 1, wherein
each of the first electrode assembly and the second electrode assembly has a structure in which a negative electrode, a positive electrode, and a separator interposed between the negative electrode and the positive electrode are stacked,
the first electrode assembly and the second electrode assembly in the electrode assembly group are arranged such that a stacking direction of the negative electrode, the positive electrode, and the separator in the first electrode assembly and a stacking direction of the negative electrode, the positive electrode, and the separator in the second electrode assembly are the same direction,
the electrode assembly group has a first electrode tab group disposed at a first end portion of the electrode assembly group, and a second electrode tab group disposed at a second end portion of the electrode assembly group opposite to the first end portion,
the outer peripheral surface of the electrode assembly group has a first end surface provided with the first electrode tab group and a second end surface provided with the second electrode tab group, and
a length of the electrode assembly group in a first direction in which the first end surface and the second end surface are arranged is larger than a length of the electrode assembly group in the stacking direction and is larger than a length of the electrode assembly group in a second direction orthogonal to the first direction and the stacking direction.

7. The secondary battery according to claim 6, wherein the second heat radiation plate is disposed between the case and each of all surfaces of the outer peripheral surface of the electrode assembly group except for the first end surface and the second end surface.

8. The secondary battery according to claim 6, wherein a relation of the following formula (I) is satisfied:
0.97≤Lhx/Lsx<1 (I), where
Lhx represents a length of the first heat radiation plate in the first direction and Lsx represents a length of the separator in the first electrode assembly or the second electrode assembly in the first direction.
